(19) United States
(12) Patent Application Publication
(10) Pub. No.: US 2008/0313201 A1
(43) Pub. Date: Dec. 18, 2008

(54) SYSTEM AND METHOD FOR COMPACT REPRESENTATION OF MULTIPLE MARKUP DATA PAGES OF ELECTRONIC DOCUMENT DATA

(76) Inventor: Christopher Mark BISHOP, Waiatarua (NZ)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/761,763

(22) Filed: Jun. 12, 2007

(51) Int. Cl. G06F 7/00; G06F 17/30

(52) U.S. Cl. 707/101; 707/E17.124

(57) ABSTRACT

The subject application is directed to a system and method for compact representation of multiple markup data pages of electronic document data. Parsed electronic page content data is first received representing a plurality of markup pages. Element code data, attribute code data, attribute data type code data and relationship map data are then generated. The received parsed electronic page content data is then compressed using the generated code data and the relationship map data. The compact markup language data is stored based upon the output of the compressed parsed electronic page content data. In addition, the generated element code data, attribute code data, attribute data type code data, and relationship map data are stored. The parsed electronic page data is regenerated in accordance with the stored element code data, the stored attribute code data, the stored attribute data type code data, and the stored relationship map data.

### BACKGROUND OF THE INVENTION

The subject application is directed generally to efficient representation of electronic documents for overlay, booklet, or N-up presentation. However, the subject application is directed more generally to any system and method in which efficient storage of data associated with page-based composition is desirable.

Many applications, such as word processing applications, output electronic documents into tangible outputs, such as a printer, or other outputs, such as a facsimile output, or the like. Often it is desirable to generate an output document that has more than one page represented concurrently on a sheet. Such is the case for N-up document generation, where two or more pages are output on a single sheet. Other such applications are for booklet form output, wherein a single sheet has pages that are oriented either on a single sheet or among multiple sheets so that a booklet is readily formed by folding sheets of printed output.

Conventional systems will typically render each such output page at a full output resolution of a document output device. In a 4-up, that is four sheets to be output on a single paper in 600 DPI laser printer, by way of example, a large amount of memory would be consumed. Four complete sheets, each at 600 DPI would be generated. Resolution would be lowered once four sheets are combined and subsequently output concurrently on the 600 DPI printer.

### SUMMARY OF THE INVENTION

In accordance with one embodiment of the subject application, there is provided a system and method for efficient representation of electronic documents for overlay, booklet, or N-up presentation.

Further, in accordance with one embodiment of the subject application, there is provided a system and method for efficient storage of data associated with page-based composition is desirable.

Still further, in accordance with one embodiment of the subject application, there is provided a system for compact representation of multiple markup data pages of electronic document data. The system includes means adapted for receiving parsed electronic page content data representative of a plurality of markup pages. The system also includes compression means, wherein the compression means includes means adapted for generating element code data, means adapted for generating attribute code data, means adapted for generating attribute data type code data, and means adapted for generating relationship map data in accordance with attribute code data and attribute data type code data. The system further includes a memory adapted for storage of compact markup language data in accordance with an output of the compression means, wherein the memory includes means adapted for storing generated element code data, means adapted for storing generated attribute code data, means adapted for storing generated attribute data type code data, and means adapted for storing relationship map data. The system also comprises decompression means adapted for regenerating parsed electronic page data in accordance with stored element code data, stored attribute code data, stored attribute data type code data, and stored relationship map data.

In one embodiment of the subject application, wherein the compact markup language data is comprised of a signature portion inclusive of data representative of an identity of a file associated with the compact markup language data, a directory portion inclusive of data representative of a plurality of portions of electronic document data corresponding to the file, and a sequence portion inclusive of data representative of a sequence of the plurality of portions.

In another embodiment of the subject application, the system further comprises an overlay file defining relative orientation of the compact markup language data.

In yet another embodiment of the subject application, the parsed electronic page content data corresponds to a plurality of markup data pages disposed in an N-up layout.

Still further, in accordance with one embodiment of the subject application, there is provided a method for compact representation of multiple markup data pages of electronic document data in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for compact representation of multiple markup data pages of electronic document data according to one embodiment of the subject application;

FIG. 2 is a block diagram illustrating controller hardware for use in the system for compact representation of multiple markup data pages of electronic document data according to one embodiment of the subject application;

FIG. 3 is a functional diagram illustrating the controller for use in the system for compact representation of multiple markup data pages of electronic document data according to one embodiment of the subject application;

FIG. 4 is a block diagram illustrating a workstation for use in the system for compact representation of multiple markup data pages of electronic document data according to one embodiment of the subject application;

FIG. 5 is a block diagram representative of a page processing system for use in the system for compact representation of multiple markup data pages of electronic document data according to one embodiment of the subject application;

FIG. 6 is a block diagram representative of a compression method for use in the system for compact representation of multiple markup data pages of electronic document data according to one embodiment of the subject application;

FIG. 7 is a block diagram representative of a compact markup page for use in the system for compact representation of multiple markup data pages of electronic document data according to one embodiment of the subject application;

FIG. 8 is a representative illustration depicting two types of part data according to FIG. 7 for use in the system for compact representation of multiple markup data pages of electronic document data according to one embodiment of the subject application; and

FIG. 9 is a flowchart illustrating a method for compact representation of multiple markup data pages of electronic document data according to one embodiment of the subject application.

### DETAILED DESCRIPTION OF THE PREFERRED EMBODIMENT

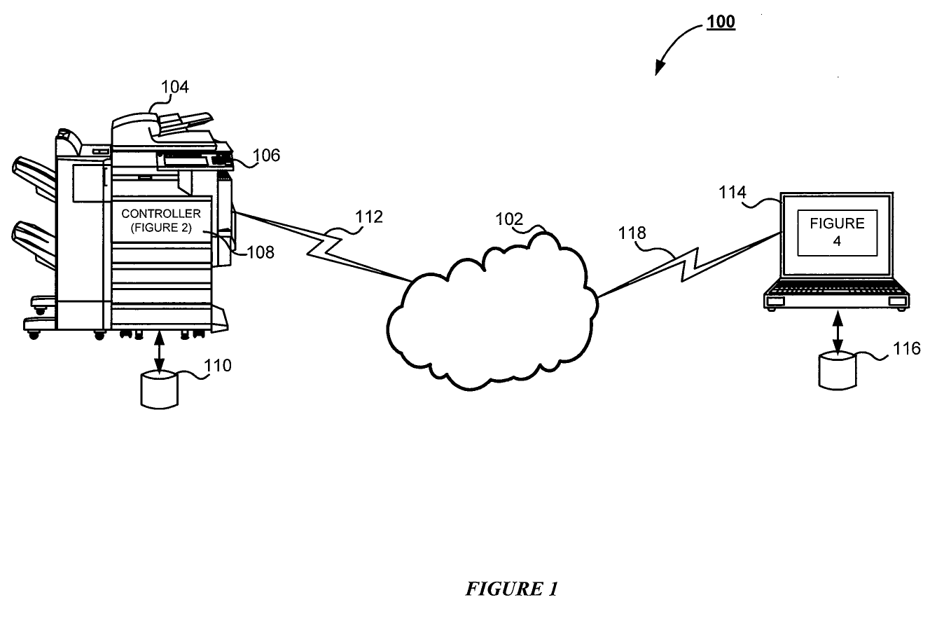

The subject application is directed to a system and method for compact representation of multiple markup data pages of electronic document data. In particular, the subject application is directed to a system and method for efficient representation of electronic documents for overlay, booklet, or N-up presentation. More particularly, the subject application is directed to a system and method for efficient storage of data associated with page-based composition is desirable. It will become apparent to those skilled in the art that the system and method described herein are suitably adapted to a plurality of varying electronic fields employing efficient storage of data associated with page-based composition is desirable, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for compact representation of multiple markup data pages of electronic document data in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11 g, 802.11(x), Bluetooth, the public switched telephone network, a proprietary communications network, infrared, optical, or any other suitable wired or wireless data transmission communications known in the art.

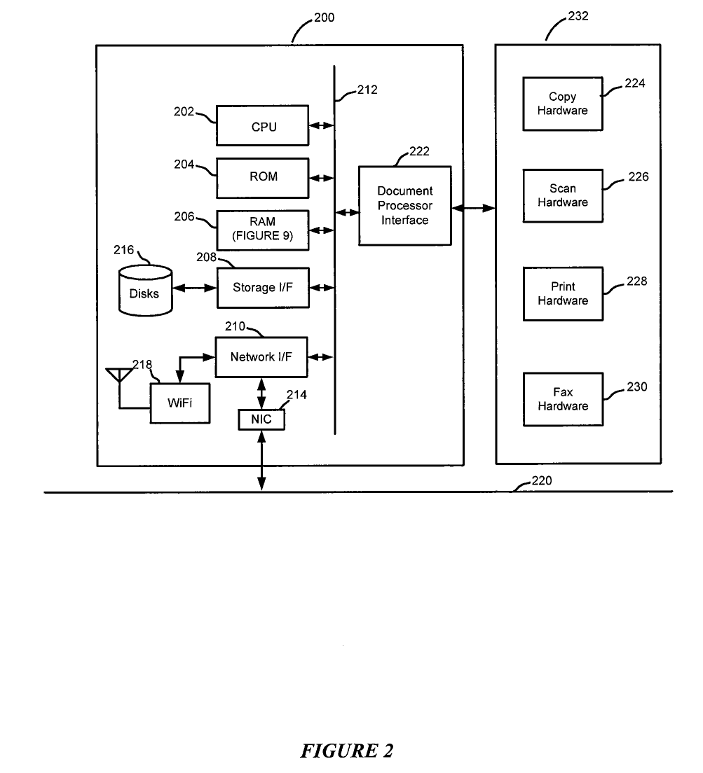

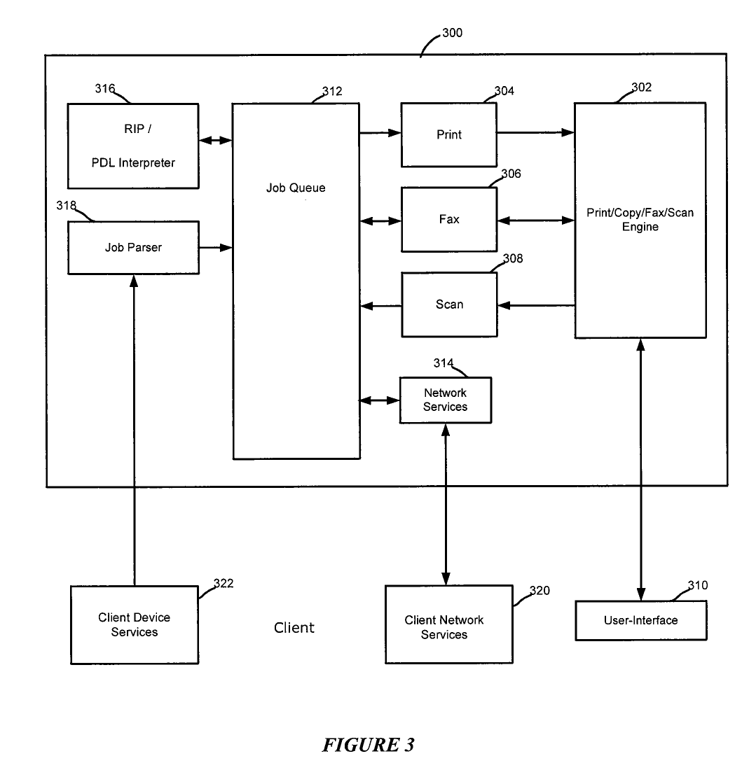

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for compact representation of multiple markup data pages of electronic document data of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, compact markup page representation data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

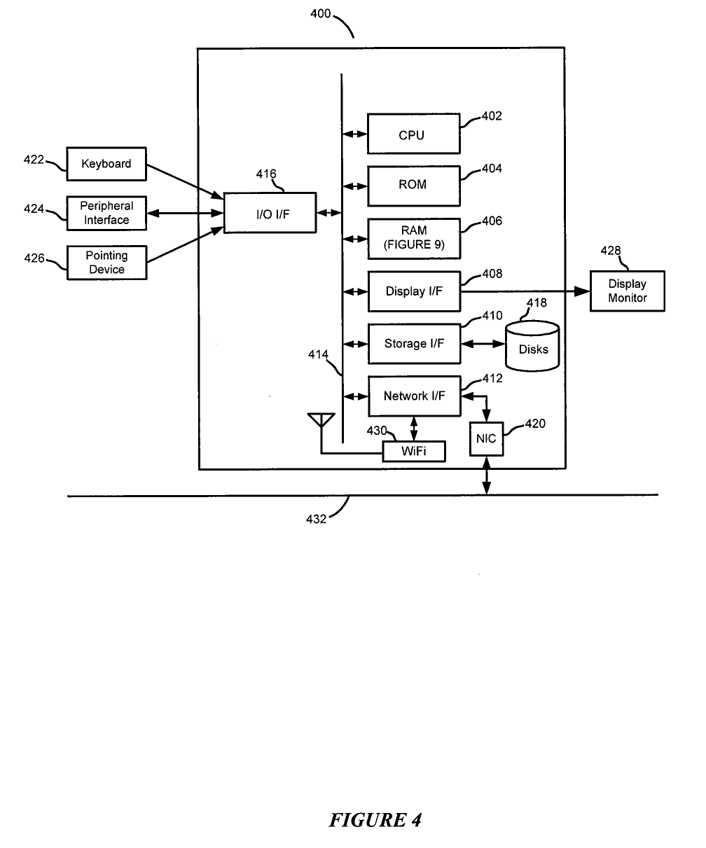

The system 100 illustrated in FIG. 1 further depicts a user device 114, in data communication with the computer network 102 via a communications link 118. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 118 is any suitable channel of data communications known in the art including, but not limited to wireless communications, for example and without limitation, Bluetooth, WiMax, 802.11a, 802.11b, 802.11 g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102. The functioning of the user device 114 will better be understood in conjunction with the block diagram illustrated in FIG. 4, explained in greater detail below.

Communicatively coupled to the user device 114 is a data storage device 116. In accordance with the preferred embodiment of the subject application, the data storage device 116 is any mass storage device known in the art including, for example and without limitation, magnetic storage drives, a hard disk drive, optical storage devices, flash memory devices, or any suitable combination thereof. In the preferred embodiment, the data storage device 116 is suitably adapted to store an operating system, compact markup page representation data, document output drivers, applications, document data, image data, electronic database data, or the like. It will be appreciated by those skilled in the art that while illustrated in FIG. 1 as being a separate component of the system 100, the data storage device 116 is capable of being implemented as internal storage component of the user device 114, such as, for example and without limitation, an internal hard disk drive, or the like.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The Parser 318 functions to interpret a received electronic document file and relay it to the job queue 312 for handling in connection with the afore-described functionality and components.

Turning now to FIG. 4, illustrated is a hardware diagram of a suitable workstation 400, shown in FIG. 1 as the user device 114, for use in connection with the subject system. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 426 for connection with devices, such as a mouse, light pen, touch screen, or the like.

Turning now to FIG. 5, there is shown a system 500 representing page processing as applied to the system 100 for compact representation of multiple markup data pages of electronic document in accordance with one embodiment of the subject application. As shown in FIG. 5, the system includes an extensible markup language page specification (“XPS”) document 502, an XPS parser 504, page content data 506, compact markup page representation storage 508, and page processing 510 components, which combine to output page data, as will be understood by those skilled in the art. The skilled artisan will appreciate that the system 500 is for illustration purposes only, and is capable of implementation within the system 100 illustrated in FIG. 1. The functioning of FIG. 5 will be explained in greater detail below.

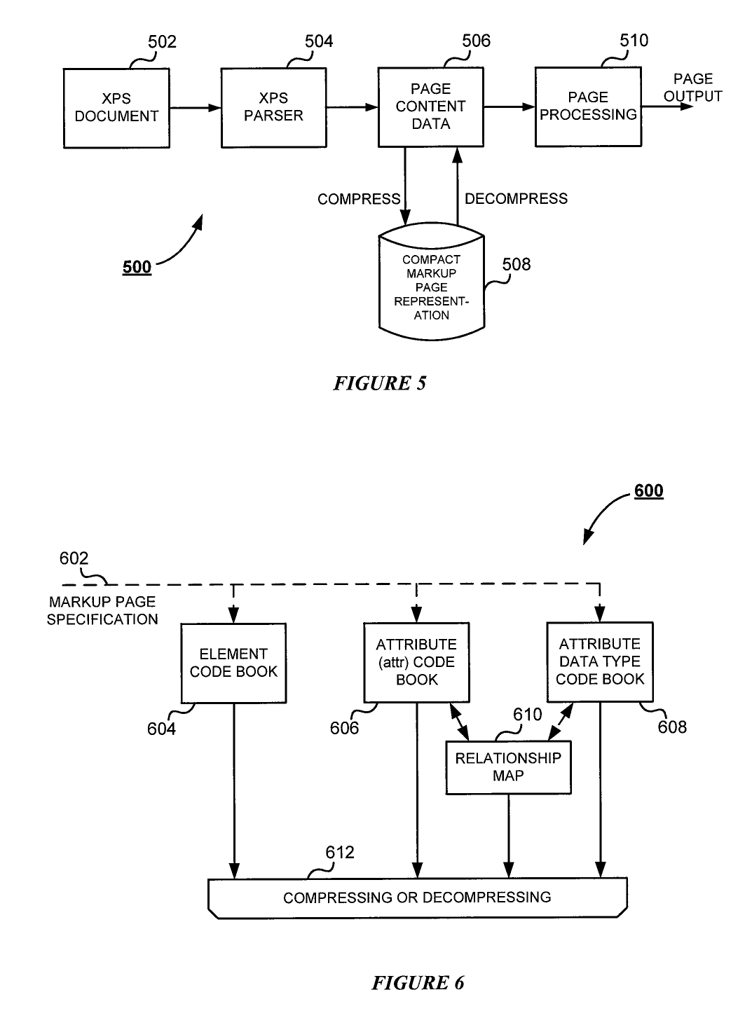

Referring now to FIG. 6, there is shown a block diagram 600 illustrating the various components used in the compression method employed by the system for compact representation of multiple markup data pages of electronic document in accordance with one embodiment of the subject application. The diagram 600 depicts a markup page specification rules 602 (e.g., XML Paper Specification) that is used to generate predetermined data associated with an element code book component 604, an attribute code book component 606, an attribute data type code book component 608, a relationship map component 610, and a compression/decompression component 612. The functioning of FIG. 6 will be explained in greater detail below in conjunction with the system 500 illustrated in FIG. 5.

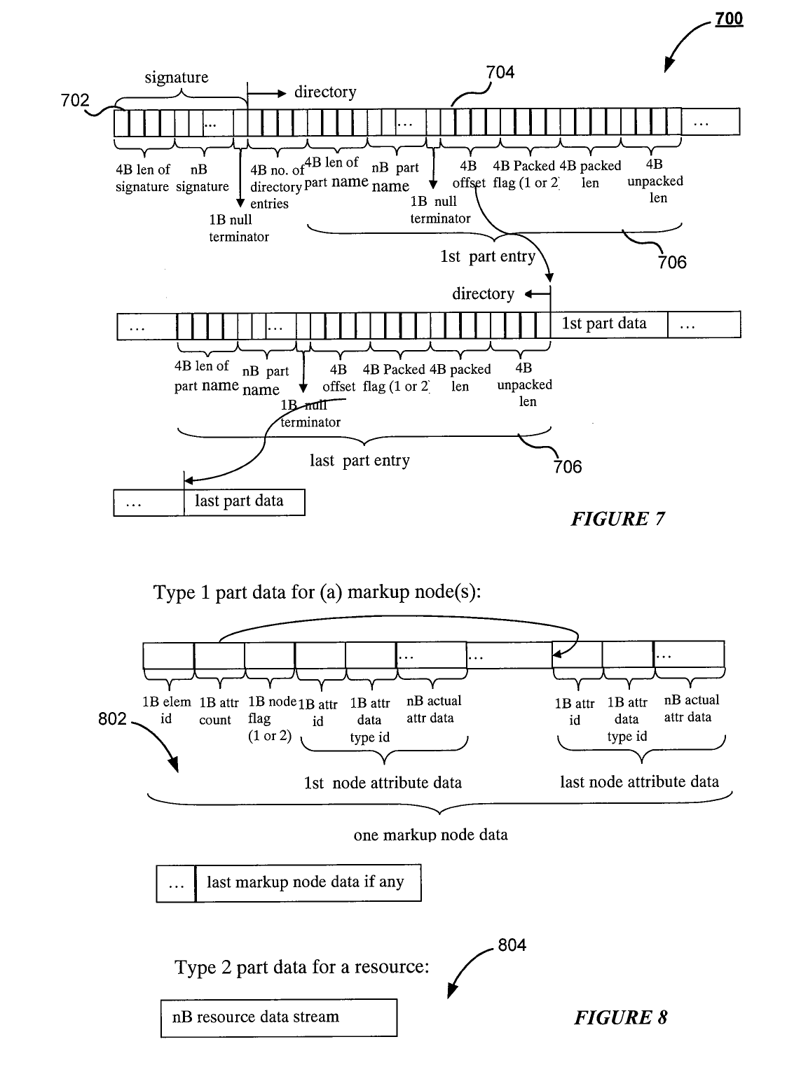

Turning now to FIG. 7, there is shown an example embodiment of the compact markup language data 700 in accordance with the system for compact representation of multiple markup data pages of electronic document according to one embodiment of the subject application. As shown in FIG. 7, the language data 700 includes a signature portion 702, a directory portion 704, and a sequence portion, represented by the parts 706. A more detailed explanation of the language data 700 of FIG. 7 is included below.

With respect to FIG. 8, there is shown example markup node data 802 and resource data 804 in accordance with one embodiment of the subject application. An explanation of FIG. 8 is included with reference to FIG. 7, discussed in greater detail below.

In operation, parsed electronic page content data is first received representing a plurality of markup pages. Element code data, attribute code data, attribute data type code data and relationship map data are then generated. The received parsed electronic page content data is then compressed using the generated element code data, attribute code data, attribute data type code data, and relationship map data. The compact markup language data is then stored based upon the output compressed parsed electronic page content data. In addition, the generated element code data, attribute code data, attribute data type code data, and relationship map data are stored. The parsed electronic page data is then regenerated in accordance with the stored element code data, the stored attribute code data, the stored attribute data type code data, and the stored relationship map data.

In accordance with one example embodiment of the subject application, an XPS document 502 is first received by a controller 108 associated with the document processing device 104, by a software driver associated with the user device 114, or the like. The received XPS document 502 is then parsed via the XPS parser 504, resulting in page content data 506. It will be appreciated by those skilled in the art that any parser known in the art capable of parsing XPS documents is capable of implementation in accordance with the subject application. In accordance with one embodiment of the subject application, the XPS parser 504 is a functionality of the raster image processor associated with the document processing device 104, a functionality of the controller 108, or other suitable component associated with the document processing device 104. The page content data 506 is then compressed so as to generate compact markup page data 508. In the generation of the compact markup page data 508, first element code book data 604 is generated using the markup page specification rules 602. The skilled artisan will appreciate that such generation is advantageously accomplished via suitable hardware, software, or any combination thereof, resident on the controller 108 associated with the document processing device 104, the user device 114, or the like.

Attribute code book data 606 is then generated, as well as attribute data type code book data 608, using the markup page specification rules 602. A relationship map 610 is generated corresponding to the relationship between the attribute code book data 606 and the attribute data type code book data 608. Using the element code book data 604, the attribute code book data 606, attribute data type code book data 608, and the relationship map 610, the parsed page content data 506 is compressed at 612 and stored as compact markup language data in the data storage 508. It will be understood by those skilled in the art that the data storage 508 is representative of any suitable storage known in the art, including, for example and without limitation, the data storage device 110, the data storage device 116, or the like. With reference now to FIG. 7, the compact markup language data 700 is comprised of a signature portion 702 inclusive of data representative of an identity of a file associated with the compact markup language data, a directory portion 704 inclusive of data representative of a plurality of portions of electronic document data corresponding to the file, and a sequence portion, represented by parts 706, inclusive of data representative of a sequence of the plurality of portions.

Thus, FIG. 7 depicts a signature portion 702, suitably configured to identify the compact markup language data file 700 in the proposed compact file format. The directory portion 704 is configured to contain information about the parts, or portions, contained in the compact language data file 700. The parts 706 are representative of a sequence of the actual portions comprising the data of the compact markup language data file 700. For example, an overlay file is generated, defining the orientation of the compact markup language data 700. The overlay file in such an example begins with a signature 702 used to identify the file as an overlay file. Preferably, as shown in FIG. 7, the signature portion 702 includes an “int len”, which defines the length of the signature string in bytes including a terminating null, a “char sig[len]” defining the signature string, and a “char terminator” defining NULL, e.g., terminating the signature.

Following the signature portion 702, the overlay file includes a directory portion 704 containing a directory of all the parts 706 contained in the file. In accordance with the example embodiment illustrated in FIG. 7, the directory portion 704 format comprises “int numparts”, which defines a count of the number of parts in the overlay file, and a “directory_entry[numparts]”, which defines a list of directory entries, one corresponding to each part 706 of the overlay file.

Each directory entry comprises the following format: “int partnamelen”, which defines the length of the name of the part 706 in bytes including terminating null; “char partname[partnamelen]”, which defines the name of the corresponding part 706; a “char terminator”, which defines the termination of the name of the part 706, e.g., NULL; a “size_t offset”, which defines the offset, in bytes, from the start of the overlay file of the data for the part 706; an “int packed”, which corresponds to a flag that indicates whether the data is packed or not packed, e.g., a zero indicates unpacked data and a non-zero indicates packed data; a “size_t packedlen”, which defines the length, in bytes, of the packed data for the part 706, e.g., if packed is equal to 0 then “packedlen” will equal “partlen”; and a “size_t partlen”, which defines the length, in bytes, of the (unpacked) data for the corresponding part 706.

Following the directory portion 704, all data for the parts 706 follows in the order in which they occur in the directory 704. It will be appreciated by those skilled in the art that preferably only a single part 706 contains binary markup data. It will also be understood by the skilled artisan that there are any number of resource parts as required for each containing just the data for that corresponding resource. The skilled artisan will further appreciate that file part of the proposed compact markup page representation that contains the page markup is a binary representation of the markup tree nodes along with any associated attributes.

Continuing with such an example, any single markup node is stored in the following FPNode node, e.g., the basic data for the node, wherein the list of actual attributes used is given by node:actualAttrCnt. As will be understood by those skilled in the art, the format of the example FPNode structure is:

| | |
|---|---|
| typedef struct | |
| { | |
| unsigned char elem; | /* XML Page element type id */ |
| unsigned char actualAttrCnt; | /* Number of attributes used */ |
| unsigned char flags; | /* Flag bits indicating existence |
| | of siblings and children */ |
| } FPNode; | |

| | |
|---|---|
| /* Values for bits of FPNode flags bits */ | |
| #define FPNODE_HAS_CHILDREN | 0x01 |
| #define FPNODE_HAS_SIBLINGS | 0x02 |

FIG. 8 illustrates two example types of part data, part data for a markup node 802 and part data for a resource 804. The skilled artisan will therefore appreciate that it is necessary to record and maintain a list of all possible types of page elements and assign each type a unique id for this purpose.

In addition, as will be understood by those skilled in the art, any attributes for the node immediately follow the basic node data, thus the format of the data for each attribute is capable of being represented by:

| | |
|---|---|
| unsigned char attrtype | a value indicating the particular |
| | attribute type for the node |
| unsigned char dataType | the data type for the attribute |
| Actual attribute data | |

It will be apparent to those skilled in the art that all possible node attributes and their data type are each respectively registered with an assigned unique number.

Preferably, the order in which node data appears in the markup file is such that data for the child nodes of a given parent node immediately follow the data for the parent node. Data for siblings of a given node follow all the data for all child nodes. Thus given a hypothetical node tree for a markup page such as:

```
<A>
  <B>
    <C />
    <D />
  </B>
  <E>
    <F />
    <G />
  </E>
</A>
```

The binary node data would be stored in the following order:

Data for node A
Data for node B
Data for node C
Data for node D
Data for node E
Data for node F
Data for node G

It will be appreciated by those skilled in the art that the preceding format is capable of being used storing any number of parts of any type. Thus, for example, XPS pages use a fixed part name <XPS-PageXXXX-Markup> as the registration name of a node tree starting with XPS Fixed page node (where XXXX can be replaced as page number), employ <XPS-NodeTreeYYYY-Markup> for any node tree beginning with any page element node but not XPS Fixed Page node (where YYYY could be used as the node serial number), and apply the original name of a resource as its part registration name. It will therefore become apparent to those skilled in the art that all nodes in a markup page are capable of registration in one part or several parts in the compact markup page representation of the subject application. In addition, all resources associated with a markup page are capable of being recorded immediately after the markup page node tree is completed or after all markup page node trees are finished. In accordance with one embodiment of the subject application, it is preferred to register a markup page tree node in one load followed by all its associated resources.

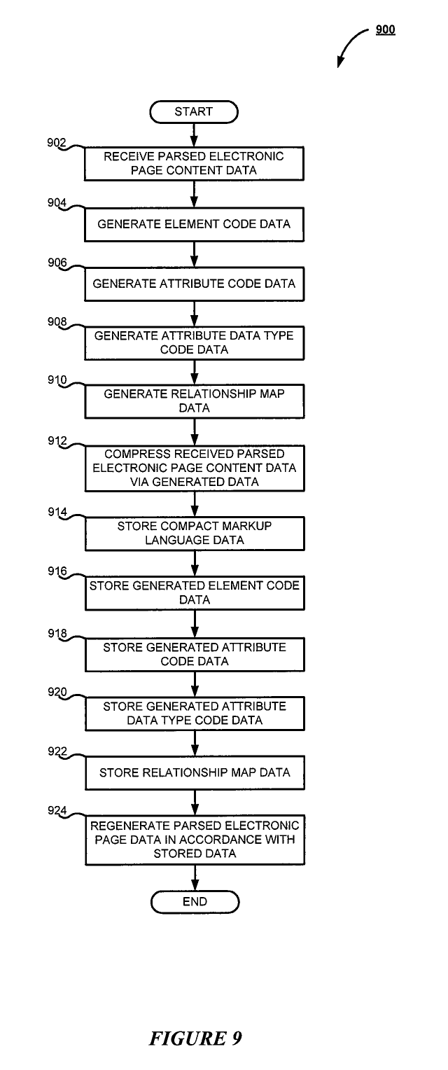

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9. Turning now to FIG. 9, there is shown a flowchart 900 illustrating a method for compact representation of multiple markup data pages of electronic document data in accordance with one embodiment of the subject application.

Beginning at step 902, parsed electronic page content data 506 representing a plurality of markup pages is first received. The skilled artisan will appreciate that such data is capable of being received by a suitable output driver associated with the user device 114, the document processing device 104, or the like. That is, a user associated with the user device 114 or the document processing device 104 directs the output, via a suitable software application resident thereon, of a plurality of pages of an electronic document. In accordance with one embodiment of the subject application, the parsed electronic page content data corresponds to a plurality of markup pages disposed in an N-up layout, an overlay, booklet layout, or the like. In accordance with one embodiment of the subject application, an XPS document 502 is pre-parsed via a suitable XPS parser 504 so as to generate the parsed electronic page content data received by the driver.

At step 904, element code data 604 is generated corresponding to the received parsed electronic page content data 506. At step 906, attribute code data 606 is generated corresponding to the received parsed electronic page content data 506. Attribute data type code data 608 is then generated at step 908 corresponding to the received parsed electronic page content data 506. Relationship map data 610 is then generated in accordance with the attribute code data 606 and the attribute data type code data 608 at step 910. Using the generated element code data 604, the attribute code data 606, the attribute data type code data 608, and the relationship map data 610, from the markup page specification rules 602, the received parsed electronic page content data 506 is compressed at step 912, resulting in compact markup language data 508. In accordance with one embodiment of the subject application, the compact markup language data 508 is comprised of a signature portion 702 inclusive of data representing an identity of a file associated with the compact markup language data, a directory portion 704 inclusive of data representing a plurality of portions of electronic document data corresponding to the file, and a sequence portion, represented by a plurality of parts 706, inclusive of data representing a sequence of the plurality of portions.

At step 914, the compact markup language data 508 is stored in the data storage device 116 associated with the user device 114, the data storage device 110 associated with the document processing device 104, or any other suitable electronic device coupled to the computer network 102 and capable of directing the output of markup language documents in accordance with the subject application. At step 916, the generated element code data 604 is stored in association with the compact markup language data 508. The generated attribute code data 606 is then stored at step 918 in association with the compact markup language data 508. At step 920, the generated attribute data type code data 608 is also stored in association with the compact markup language data 508. The relationship map data 610, corresponding to the attribute code data 606 and the attribute data type code data 608, is stored at step 922, in association with the compact markup language data 508.

At step 924, the parsed electronic page data 506, that conforms to the markup page specification rules 602 of FIG. 6, is regenerated in accordance with the stored element code data 604, the stored attribute code data 606, the stored attribute data type code data 608, and the relationship map data 610. That is, the document processing device 104, via the controller 108, regenerates the parsed electronic page data 506 (shown in FIG. 6 as the markup page specification 602) from the compact markup language data 508 using the stored code data 604-608 and the stored relationship map data 610. The document processing device 104 is then capable of outputting the electronic page data 506 in accordance with user selected document processing operations, e.g., printing an N-up document, printing a booklet document, or the like.

TABLE 1, included below, illustrates various comparisons between the sizes of files when output as XPS data and when output as overlay data in accordance with one embodiment of the subject application. For purposes of example only, three files are used for comparison, each file comprising a single page, and corresponding, respectively, to an image file, containing only a single image output, a text file, containing only text output in a number of fonts, and a graphics file, containing only line graphics output.

TABLE 1

| | | | | | Compact/ |
|---|---|---|---|---|---|
| | | | Compact | | XPS |
| File | | | file | XPS file | (%) |
| Image | File size | | 179538 | 189256 | 94.8% |
| | Markup | Packed | 212 | 468 | 45.3% |
| | | Unpacked | 264 | 835 | 31.6% |
| | | Process | 264 | 1099 | 24.0% |
| | | Memory | | | |
| | | Usage* | | | |
| | Resources (.tiff | Packed | 179184 | 181872 | 98.5% |
| | image) | Unpacked | 405440 | 405440 | 100% |
| Text | File size | | 135685 | 144215 | 94.1% |
| | Markup | Packed | 5266 | 6973 | 75.5% |
| | | Unpacked | 22679 | 30126 | 75.3% |
| | | Process | 22679 | 52805 | 42.9% |
| | | Memory | | | |
| | | Usage* | | | |
| | Resources | Packed | 129890 | 130951 | 99.2% |
| | (fonts) | Unpacked | 49251 | 49251 | 100% |
| graphics | File size | | 7865 | 11578 | 67.9% |
| | Markup | Packed | 7796 | 7931 | 98.3% |
| | | Unpacked | 31954 | 35319 | 90.4% |
| | | Process | 31954 | 67273 | 47.5% |
| | | Memory | | | |
| | | Usage* | | | |

It will be appreciated by those skilled in the art that as shown in TABLE 1, the overall saving in file size is greatest when no resources are attributed to the file, i.e., the size of the resources is comparable in either format, .tiff images in the image file and fonts in the text file. The skilled artisan will appreciate that the graphics file illustrates the greater saving as the file does not contain any resources. In addition, the savings in markup size is greatest when there is less additional attribute data for the markup. For example, the text file and the graphics file have significant attribute data in the form of text strings and abbreviated geometry strings, whereas the image file has little additional attribute data. The skilled artisan will appreciate that the invention refers to compression of mark up data, therefore, the greatest compression is achieved when the input data contain a high percentage of mark up data. Any resource files (e.g. TIFF images, font files) are not a part of the mark up data.

It will be appreciated by those skilled in the art that one of the main advantages of the subject application is not capable of depiction in TABLE 1. That is, the markup data in the compact markup page representation data is pre-parsed, i.e., it is capable of being directly operated upon, while the XPS data requires parsing prior to use. Thus, when being processed, the above unpacked figures for the compact file format are representative of actual memory usage. Conversely, when using XPS format, the XPS data will first need parsing into a compatible format and memory usage in this case will effectively be the sum of the unpacked overlay file and the XPS markup figures. This is indicated by the Process Memory Usage figures in the table which are estimated only.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs, or the like. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for compact representation of multiple markup data pages of electronic document data comprising:
means adapted for receiving parsed electronic page content data representative of a plurality of markup pages;
compression means including,
means adapted for generating element code data,
means adapted for generating attribute code data,
means adapted for generating attribute data type code data, and
means adapted for generating relationship map data in accordance with attribute code data and attribute data type code data;
a memory adapted for storage of compact markup language data in accordance with an output of the compression means, the memory including,
means adapted for storing generated element code data,
means adapted for storing generated attribute code data,
means adapted for storing generated attribute data type code data, and
means adapted for storing relationship map data; and
decompression means adapted for regenerating parsed electronic page data in accordance with stored element code data, stored attribute code data, stored attribute data type code data, and stored relationship map data.

2. The system of claim 1 wherein the compact markup language data is comprised of a signature portion inclusive of data representative of an identity of a file associated with the compact markup language data, a directory portion inclusive of data representative of a plurality of portions of electronic document data corresponding to the file, and a sequence portion inclusive of data representative of a sequence of the plurality of portions.

3. The system of claim 2 further comprising an overlay file defining relative orientation of the compact markup language data.

4. The system of claim 1 wherein the parsed electronic page content data corresponds to a plurality of markup data pages disposed in an N-up layout.

5. A method for compact representation of multiple markup data pages of electronic document data comprising the steps of:
receiving parsed electronic page content data representative of a plurality of markup pages;
compressing received parsed electronic page content data, wherein the step of compressing includes,
generating element code data;
generating attribute code data;
generating attribute data type code data, and
generating relationship map data in accordance with attribute code data and attribute data type code data;
storing compact markup language data in accordance with an output of the compression step, including,
storing generated element code data,
storing generated attribute code data,
storing generated attribute data type code data, and
storing relationship map data; and
regenerating parsed electronic page data in accordance with stored element code data, stored attribute code data, stored attribute data type code data, and stored relationship map data.

6. The method of claim 5 wherein the compact markup language data is comprised of a signature portion inclusive of data representative of an identity of a file associated with the compact markup language data, a directory portion inclusive of data representative of a plurality of portions of electronic document data corresponding to the file, and a sequence portion inclusive of data representative of a sequence of the plurality of portions.

7. The method of claim 6 further comprising the step of generating an overlay file defining relative orientation of the compact markup language data.

8. The method of claim 5 wherein the parsed electronic page content data corresponds to a plurality of markup data pages disposed in an N-up layout.
